(19) United States
(12) Patent Application Publication
(10) Pub. No.: US 2021/0347009 A1
(43) Pub. Date: Nov. 11, 2021

(54) GRINDING APPARATUS

(71) Applicant: DISCO CORPORATION, Tokyo (JP)

(72) Inventors: Suguru HIRAIWA, Tokyo (JP); Noboru TAKEDA, Tokyo (JP)

(21) Appl. No.: 17/233,671

(22) Filed: Apr. 19, 2021

(30) Foreign Application Priority Data
May 7, 2020 (JP) 2020-082216

(51) Int. Cl. B24B 53/007; B05B 17/06

(52) U.S. Cl. CPC B24B 53/007; B05B 17/0607

(57) ABSTRACT

A grinding apparatus includes an ultrasonic cleaning unit. The ultrasonic cleaning unit includes a pair of side walls that surround the inside and the outside of a base and grindstones, a bottom surface that connects the pair of side walls, a jet port that is formed in at least either of the side walls or the bottom surface and that jets a cleaning liquid toward at least either of the base or the grindstones, a cleaning liquid supply section that supplies the cleaning liquid to the jet port; an ultrasonic vibrator that applies an ultrasonic wave to the cleaning liquid supplied from the cleaning liquid supply section, and an electric power supply section that applies electric power to the ultrasonic vibrator.

### BACKGROUND OF THE INVENTION

### Field of the Invention

The present invention relates to a grinding apparatus.

### Description of the Related Art

In a grinding apparatus in which a workpiece on a holding table which is rotated is ground by a grinding wheel including a plurality of grindstones arranged in an annular pattern, a configuration in which cleaning liquid is jetted toward grinding surfaces of the grindstones to clean the grinding surfaces has been known (see, for example, Japanese Patent Laid-open No. 2015-202545).

### SUMMARY OF THE INVENTION

Grinding apparatuses include those in which a grinding wheel including an annular base and a plurality of grindstones fixed to the base is used. In such a grinding apparatus, there has been a problem that, when the grinding wheel is rotated or the grinding wheel is exchanged in a state in which the base is contaminated, the processing chamber would be contaminated. There has been also a problem that the dirt on the base may drop onto the holding table or into the grinding apparatus at the time of exchange of the grinding wheel, and there is a possibility of adhesion of the dirt to the workpiece after grinding.

Accordingly, it is an object of the present invention to provide a grinding apparatus capable of cleaning a base of a grinding wheel.

In accordance with an aspect of the present invention, there is provided a grinding apparatus including a holding table that holds a workpiece and that is rotated, a grinding wheel including an annular base fixed to a rotary spindle and a plurality of grindstones fixed to the base, and an ultrasonic cleaning unit that cleans the annular base, in which the ultrasonic cleaning unit includes side walls that surround the inside and the outside of the base and the grindstones, a bottom surface that connects the side walls, a jet port that is formed in at least either of the side walls or the bottom surface and that jets cleaning liquid toward either of the base or the grindstones, a cleaning liquid supply section that supplies the cleaning liquid to the jet port, an ultrasonic vibrator that applies an ultrasonic wave to the cleaning liquid supplied from the cleaning liquid supply section, and an electric power supply section that applies electric power to the ultrasonic vibrator.

Preferably, the bottom surface is connected to a cleaning liquid discharge pipe, and is inclined so as to be lowered toward the part with which the cleaning liquid discharge pipe is connected.

Preferably, the ultrasonic vibrator is disposed at at least either of the side wall or the bottom surface.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a sectional view depicting a configuration example of a grinding apparatus according to a first embodiment;

FIG. 2 is a top plan view depicting positional relations among components of the grinding apparatus of FIG. 1;

FIG. 3 is a sectional view in which an ultrasonic cleaning unit of the grinding apparatus of FIG. 1 is enlarged;

FIG. 4 is a perspective view of the ultrasonic cleaning unit of the grinding apparatus of FIG. 1, as viewed from another angle;

FIG. 5 is a perspective view depicting a water passage of the ultrasonic cleaning unit of FIG. 3;

FIG. 6 is a sectional view in which a major part of a grinding apparatus according to a second embodiment is enlarged;

FIG. 7 is a sectional view in which a major part of a grinding apparatus according to a third embodiment is enlarged;

FIG. 8 is a sectional view in which a major part of a grinding apparatus according to a modification is enlarged;

FIG. 9 is a perspective view depicting an ultrasonic cleaning unit of the grinding apparatus of FIG. 8; and

FIG. 10 is a perspective view depicting a water passage of the ultrasonic cleaning unit of FIG. 8.

### DETAILED DESCRIPTION OF THE PREFERRED EMBODIMENTS

Embodiments of the present invention will be described in detail below referring to the drawings. The present invention is not to be limited by the contents described in the following embodiments. In addition, the following components include those which can be easily conceived by a person skilled in the art, and those which are substantially the same. Further, the following configurations can be combined with one another, as required. Besides, various omissions, replacements or modifications of the configuration are possible within such ranges as not to depart from the gist of the invention.

### First Embodiment

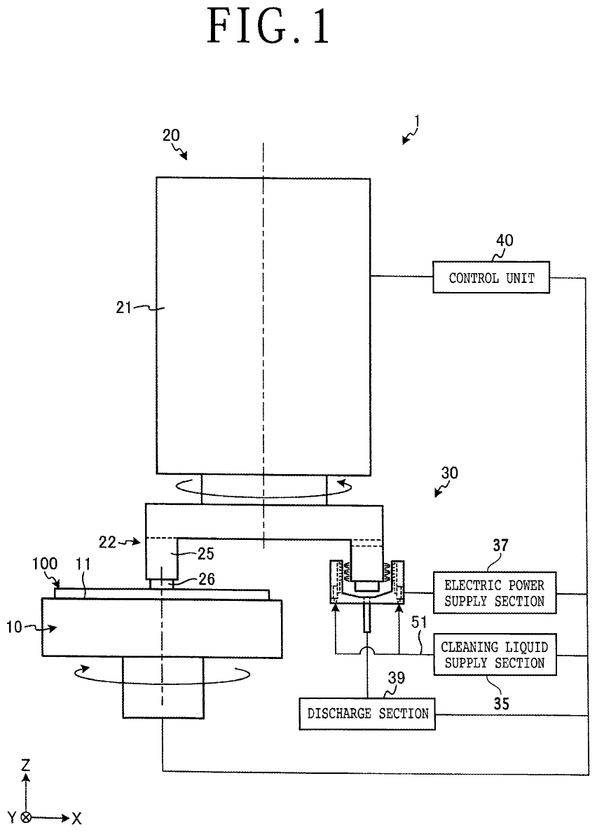

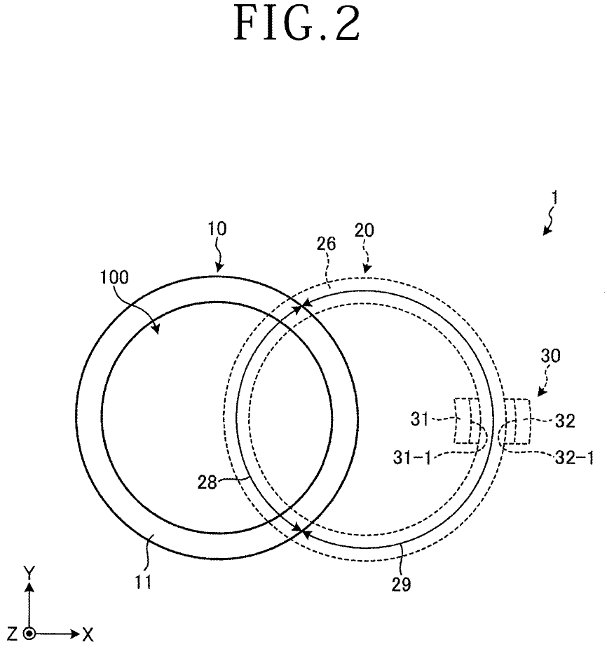

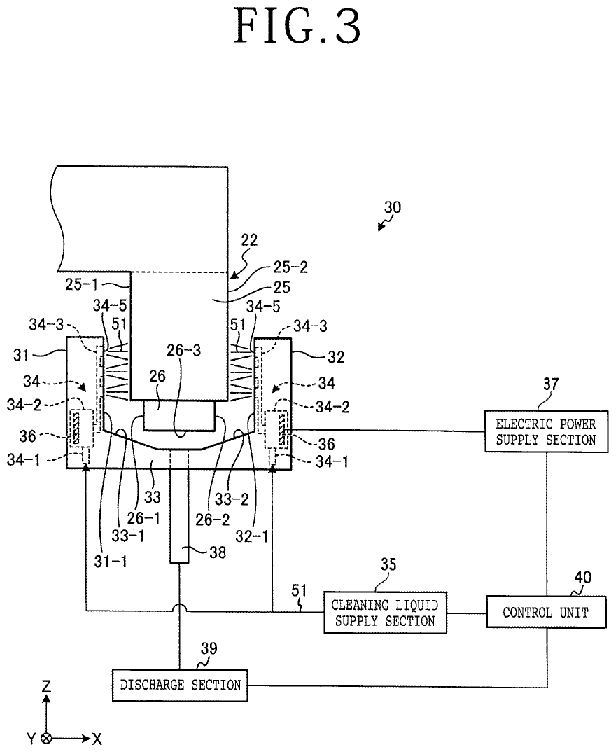

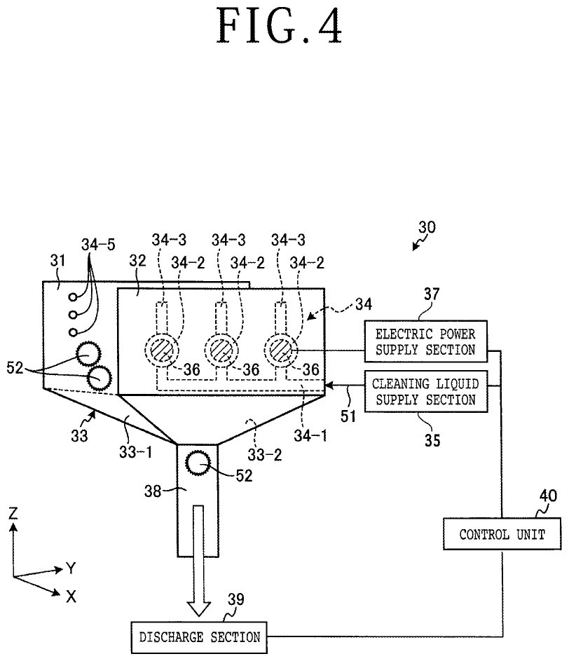

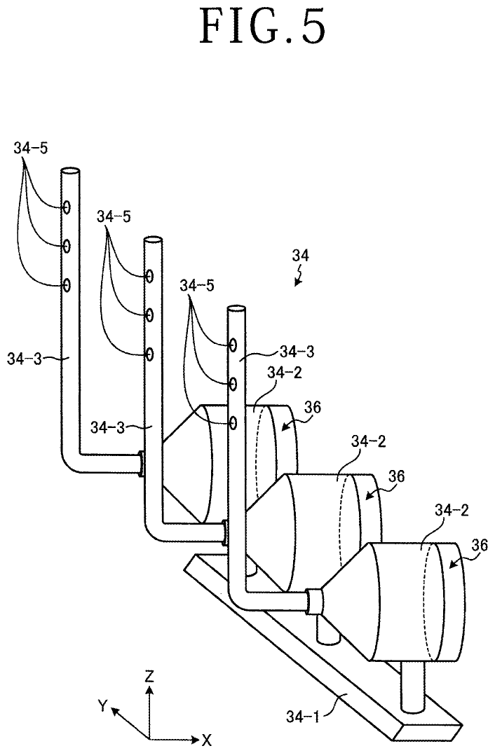

A grinding apparatus 1 according to a first embodiment of the present invention will be described based on the drawings. FIG. 1 is a sectional view depicting a configuration example of the grinding apparatus 1 according to the first embodiment. FIG. 2 is a top plan view depicting positional relations among components of the grinding apparatus 1 of FIG. 1. FIG. 3 is a sectional view in which an ultrasonic cleaning unit 30 of the grinding apparatus 1 of FIG. 1 is enlarged. FIG. 4 is a perspective view depicting the ultrasonic cleaning unit 30 of the grinding apparatus of FIG. 1, as viewed from another angle. FIG. 5 is a perspective view depicting a water passage 34 of the ultrasonic cleaning unit 30 of FIG. 3. As illustrated in FIG. 1, the grinding apparatus 1 includes a holding table 10, a grinding unit 20, the ultrasonic cleaning unit 30, and a control unit 40. The grinding apparatus 1 grinds a workpiece 100 held on the holding table 10 by the grinding unit 20.

The workpiece 100 as an object of griding by the grinding apparatus 1 is, for example, a wafer such as a disk-shaped semiconductor wafer or an optical device wafer having silicon, sapphire, gallium arsenide, or the like as a base material. The workpiece 100 is, for example, formed with devices in regions partitioned by a plurality of streets formed in a grid pattern on a flat front surface thereof, and is ground from the side of a back surface opposite to the front surface. In addition, in the present invention, the workpiece 100 may be a rectangular package substrate, a ceramic substrate, a glass substrate, or the like having a plurality of devices sealed with a resin.

As depicted in FIG. 1, the holding table 10 has a holding surface 11 parallel to a horizontal plane and directed to the upper side. A suction source not illustrated is connected to the holding table 10, and the workpiece 100 is held under suction on the holding surface 11 by a negative pressure supplied from the suction source. A rotational driving section not illustrated is connected to the holding table 10, and the holding table 10 can be rotated by the rotational driving section.

As illustrated in FIG. 1, the grinding unit 20 includes a rotary spindle 21 and a grinding wheel 22. The grinding wheel 22 includes an annular base 25 fixed to a lower end of the rotary spindle 21, and a plurality of grindstones 26 fixed to the base 25 and arranged in an annular pattern. The grinding unit 20, while rotating the grinding wheel 22 by the rotary spindle 21, presses the grinding wheel 22 against the workpiece 100 held on the holding surface 11 of the rotating holding table 10 along a Z-axis direction, thereby grinding the workpiece 100.

As depicted in FIG. 2, in the grinding apparatus 1, the rotational center of the holding table 10 and the rotational center of the grinding wheel 22 are deviated from each other in a horizontal direction (X-axis direction in FIG. 1). In the grinding apparatus 1, as illustrated in FIG. 2, the route along which the base 25 and the grindstones 26 pass when the grinding wheel 22 is rotated has an on-table route 28 in a region facing the holding surface 11 of the holding table 10 in the Z-axis direction, and an outside-table route 29 outside the region facing the holding surface 11 of the holding table 10 in the Z-axis direction. In the grinding apparatus 1, as depicted in FIG. 2, the ultrasonic cleaning unit 30 is disposed to clamp from below the base 25 and the grindstones 26 passing the outside-table route 29. While only one ultrasonic cleaning unit 30 is disposed in the grinding apparatus 1 in the example illustrated in FIG. 2, a plurality of ultrasonic cleaning units 30 may be disposed on the outside-table route 29 at an optional interval. In addition, in the grinding apparatus 1, the ultrasonic cleaning unit 30 may be formed in an arcuate shape in a wider range along the outside-table route 29 than that in FIG. 2.

As illustrated in FIGS. 1, 2, 3, 4 and 5, the ultrasonic cleaning unit 30 has side walls 31 and 32, a bottom surface 33, a first water passage 34-1 and an ultrasonic wave applying space 34-2 and a second water passage 34-3 and jet ports 34-5, a cleaning liquid supply section 35, ultrasonic vibrators 36, an electric power supply section 37, a cleaning liquid discharge pipe 38, and a discharge section 39.

The side wall 31 is a member having a certain thickness (first side wall member) which is provided to face radial inner circumferential surfaces 25-1 and 26-1 of the base 25 and the grindstones 26 passing the outside-table route 29 and to face the base 25 and the grindstones 26 in the radial direction. The side wall 31 has an outer wall surface 31-1 facing an inner circumferential surface 25-1 and inner circumferential surfaces 26-1 of the base 25 and the grindstones 26 in the radial direction, the outer wall surface 31-1 being formed in a curved surface shape protuberant radially outward along the inner circumferential surfaces 25-1 and 26-1. The side wall 32 is a member having a certain thickness (second side wall member) which faces radial outer circumferential surfaces 25-2 and 26-2 of the base 25 and the grindstones 26 passing the outside-table route 29 and which faces the base 25 and the grindstones 26 in the radial direction. The side wall 32 has an inner wall surface 32-1 facing an outer circumferential surface 25-2 of the base 25 and outer circumferential surface 26-2 of the grindstones 26 in the radial direction, the inner wall surface 32-1 being formed in a curved surface shape protuberant radially outward along the outer circumferential surfaces 25-2 and 26-2. The side walls 31 and 32 surround the inside and the outside of each of the base 25 and the grindstones 26. The bottom surface 33 is a member having a certain thickness (bottom surface member) which is provided to face, on the lower side of, the grindstone 26 passing the outside-table route 29. The bottom surface 33 connects lower ends of the side walls 31 and 32, and connects the side walls 31 and 32 on the lower side and in the radial direction. The bottom surface 33 faces, in the vertical direction, grinding surfaces 26-3 of the grindstones that are surfaces for grinding the workpiece 100. The side walls 31 and 32 and the bottom surface 33 together form a roughly U-shaped member, and the base 25 and the grindstones 26 passing the outside-table route 29 are clamped from below by a groove portion of the roughly U-shaped member.

As depicted in FIGS. 3 and 4, the side walls 31 and 32 are respectively formed therein with water passages 34. As illustrated in FIGS. 3, 4 and 5, the water passages 34 have a first water passage 34-1, a plurality of ultrasonic wave applying spaces 34-2, second water passages 34-3 in the same numbers as the ultrasonic wave applying spaces 34-2, and jet ports 34-5 formed in the second water passages 34-3. The first water passage 34-1 is a thin branched water passage pipe, one end thereof is connected to the cleaning liquid supply section 35, a central portion thereof is branched into a plurality of (in the first embodiment, three) water passages, and the other ends thereof are respectively connected to the ultrasonic wave applying spaces 34-2.

The ultrasonic wave applying spaces 34-2 are spaces, for example, cylindrical in outer shape provided in plurality in the side walls 31 and 32, and ultrasonic vibrators 36 are disposed therein. In the first embodiment, three ultrasonic wave applying sections 34-2 are provided in each of the side walls 31 and 32, connection sections formed at one-side ends thereof are connected to the other end of the first water passage 34-1, and the other-side ends thereof are connected with the second water passages 34-3. The second water passages 34-3 are individually thin water passage pipes, one-side ends thereof are connected to the ultrasonic wave applying spaces 34-2, and are formed on the other end side with a plurality of (in the first embodiment, three) jet ports 34-5 opening in an outer wall surface 31-1 and an inner wall surface 32-1 of the respective side walls 31 and 32. Note that the jet ports 34-5 may be formed in a tubular shape extending from the second water passage 34-3 toward the outer wall surface 31-1 and the inner wall surface 32-1 as depicted in FIGS. 3 and 4, or may be formed directly in the second water passages 34-3 as depicted in FIG. 5.

In the first embodiment, the first water passage 34-1, the ultrasonic wave applying spaces 34-2, the second water passages 34-3, and the jet ports 34-5 constituting the water passages 34 are all formed of a ceramic or quartz glass. In the example depicted in FIGS. 3, 4 and 5, the water passages 34 has three ultrasonic wave applying spaces 34-2 and three second water passages 34-3 in each of the side walls 31 and 32, and has nine jet ports 34-5, but the number of these components are not limited to this in the present invention.

The cleaning liquid supply section 35, under the control of the control unit 40, supplies a predetermined amount of cleaning liquid 51 at a predetermined pressure to the jet ports 34-5 through the respective water passages 34 formed inside the side walls 31 and 32. In the first embodiment, the cleaning liquid 51 supplied by the cleaning liquid supply section 35 is, for example, pure water or cleaning water containing a detergent. The cleaning liquid 51 supplied from the cleaning liquid supply section 35 into the water passages 34 passes through the inside of the first water passage 34-1, is supplied to the ultrasonic wave applying spaces 34-2, has an ultrasonic wave applied thereto by the ultrasonic vibrators 36 in the inside of the ultrasonic wave applying spaces 34-2, passes through the second water passages 34-3, and is jetted from the jet ports 34-5 at a predetermined pressure.

The jet ports 34-5 formed in the outer wall surface 31-1 of the side wall 31 jets the cleaning liquid 51 supplied from the cleaning liquid supply section 35 toward the inner circumferential surface 25-1 of the base 25 passing the outer circumferential side of the side wall 31, thereby cleaning the inner circumferential surface 25-1 of the base 25 passing on the outer circumferential side of the side wall 31. The jet ports 34-5 formed in the inner wall surface 32-1 of the side wall 32 jets the cleaning liquid 51 supplied from the cleaning liquid supply section 35 toward the outer circumferential surface 25-2 of the base 25 passing on the inner circumferential side of the side wall 32, thereby cleaning the outer circumferential surface 25-2 of the base 25 passing on the inner circumferential side of the side wall 32.

As illustrated in FIGS. 3, 4 and 5, the ultrasonic vibrators 36 are disposed in the ultrasonic wave applying spaces 34-2 of the respective water passages 34 formed inside the side walls 31 and 32, and apply an ultrasonic wave to the cleaning liquid 51 passing through the inside of the ultrasonic wave applying spaces 34-2. In the first embodiment, the ultrasonic vibrator 36 is a throw-in type ultrasonic vibrator disposed inside the ultrasonic wave applying space 34-2 or a nozzle-type ultrasonic vibrator inserted in the ultrasonic wave applying space 34-2. The electric power supply section 37 is electrically connected to the ultrasonic vibrators 36, and, under the control of the control unit 40, applies electric power to the ultrasonic vibrators 36, thereby realizing an ultrasonic wave applying function of the ultrasonic vibrators 36.

The cleaning liquid discharge pipe 38 is provided in a radially central portion of the bottom surface 33 while penetrating the bottom surface 33 in the vertical direction, its end portion on the upper side is opening in the bottom surface 33, and its end portion on the lower side is connected to the discharge section 39. The bottom surface 33 has an inclined surface 33-1 inclined such that a radially central portion is lowered from the radially inner circumferential side in connection with the side wall 31 toward the radially central portion in connection with the cleaning liquid discharge pipe 38, on the side of a surface facing the grinding surface 26-3.

In the ultrasonic cleaning unit 30, the cleaning liquid 51 jetted from the jet ports 34-5 on the side wall 31 side cleans the inner circumferential surface 25-1 of the base 25 to become a cleaning water liquid 52 containing dirt such as grinding swarf, and the cleaning waste liquid 52 is guided along the inclined surface 33-1 to the cleaning liquid discharge pipe 38.

In addition, the bottom surface 33 has an inclined surface 33-2 inclined such that a radially central portion is lowered from the radially outer circumferential side in connection with the side wall 32 toward the radially central portion in connection with the cleaning liquid discharge pipe 38, on the side of a surface facing the grinding surface 26-3. In the ultrasonic wave applying unit 30, the cleaning liquid 51 jetted from the jet ports 34-5 on the side wall 32 side cleans the outer circumferential surface 25-2 of the base 25 to become the cleaning waste liquid 52 containing dirt such as grinding swarf, and the cleaning waste liquid 52 is guided along the inclined surface 33-2 to the cleaning liquid discharge pipe 38.

The discharge section 39 is connected to an end portion on the lower side of the cleaning liquid discharge pipe 38. The discharge section 39, under the control of the control unit 40, sucks the cleaning waste liquid 52 guided to the cleaning liquid discharge pipe 38, and discharges it to the outside of the ultrasonic cleaning unit 30.

The control unit 40 controls each of the components of the grinding apparatus 1, thereby to realize a grinding treatment by the grinding apparatus 1 and a cleaning treatment of the base 25 of the grinding wheel 22 by the ultrasonic cleaning unit 30. The control unit 40 grinds the workpiece 100 by the grinding wheel 22, according, for example, to grinding conditions for the workpiece 100 inputted and set by the operator. In addition, the control unit 40 cleans the base 25 of the grinding wheel 22 by the ultrasonic cleaning unit 30, according to cleaning conditions for the base 25 of the grinding wheel 22 inputted and set by the operator.

In the first embodiment, the control unit 40 includes a computer system. The control unit 40 has an arithmetic processing device having a microprocessor such as a central processing unit (CPU), a storage device such as a read only memory (ROM) or a random access memory (RAM), and an input-output interface device. The arithmetic processing device of the control unit 40 executes an arithmetic process according to a computer program stored in the storage device, and outputs control signals for controlling the control unit 40 to each of the components of the grinding apparatus 1 through the input-output interface device, thereby realizing control functions of the control unit 40.

The grinding apparatus 1 according to the first embodiment configured as above, during grinding of the workpiece 100 by the grinding unit 20, has the ultrasonic cleaning unit 30 jetting the cleaning liquid 51 supplied from the cleaning liquid supply section 35 from the jet ports 34-5 formed in the side walls 31 and 32 toward the inner circumferential surface 25-1 and the outer circumferential surface 25-2 of the base 25 of the grinding wheel 22 passing the outside-table route 29 while applying an ultrasonic wave to the cleaning liquid 51 by the ultrasonic vibrators 36 and the electric power supply section 37, thereby producing an effect that the inner circumferential surface 25-1 and the outer circumferential surface 25-2 of the base 25 of the grinding wheel 22 having carried out a grinding process at the on-table route 28 can be cleaned. In addition, the grinding apparatus 1 according to the first embodiment has the ultrasonic cleaning unit 30 surrounding the inner circumferential side and the outer circumferential side of the base 25 as an object of cleaning, and supplying the cleaning liquid 51 having an ultrasonic wave applied thereto from point-blank range, and, therefore, a cleaning effect is high. As a result, the grinding apparatus 1 according to the first embodiment produces an effect that the possibility that the dirt of the base 25 may drop onto the holding table 10 or into the grinding apparatus 1 at the time of exchanging the grinding wheel 22 can be reduced and the possibility of adhesion of the dirt to the workpiece 100 after grinding can be reduced.

In addition, the grinding apparatus 1 according to the first embodiment has the bottom surface 33 connected to the cleaning liquid discharge pipe 38 on the side of the surface facing the grinding surfaces 26-3, and has the bottom surface 33 formed with the inclined surfaces 33-1, 33-2 inclined such that the part in connection with the cleaning liquid discharge pipe 38 is lowered. Therefore, the grinding apparatus 1 according to the first embodiment produces an effect that the inclined surfaces 33-1, 33-2 can preferably guide the cleaning liquid waste liquid 52 after cleaning the inner circumferential surface 25-1 and the outer circumferential surface 25-2 of the base 25 to the cleaning liquid discharge pipe 38, and can preferably discharge the cleaning waste liquid 52 to the outside of the ultrasonic cleaning unit 30 through the discharge section 39.

Besides, the grinding apparatus 1 according to the first embodiment has the ultrasonic vibrators 36 disposed in the water passages 34 formed in the side walls 31 and 32. Therefore, the grinding apparatus 1 according to the first embodiment produces an effect that the inner circumferential surface 25-1 and the outer circumferential surface 25-2 of the base 25 can be cleaned with the cleaning liquid 51 which has an ultrasonic wave applied thereto by the ultrasonic vibrators 36 immediately before being jetted and which has a high cleaning power.

### Second Embodiment

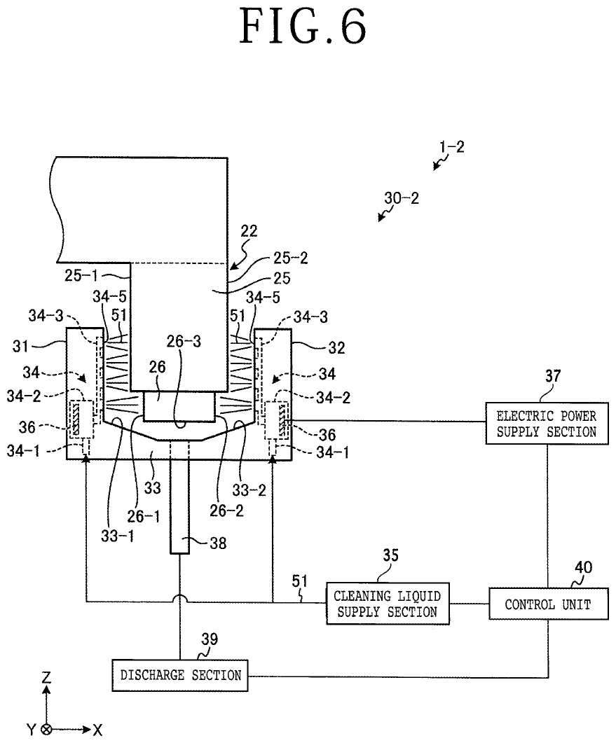

A grinding apparatus 1-2 according to a second embodiment of the present invention will be described based on the drawings. FIG. 6 is a sectional view in which a major part of the grinding apparatus 1-2 according to the second embodiment is enlarged. FIG. 6 denotes the same parts as those in the first embodiment by the same reference characters as used above, and descriptions thereof are omitted.

As illustrated in FIG. 6, an ultrasonic cleaning unit 30-2 of the grinding apparatus 1-2 according to the second embodiment has jet ports 34-5 for jetting the cleaning liquid 51 toward the inner circumferential surface 26-1 and the outer circumferential surface 26-2 and being additionally formed in the second water passages 34-3 in the inside of the side walls 31 and 32 in addition to the jet ports 34-5 for jetting the cleaning liquid 51 toward the inner circumferential surface 25-1 and the outer circumferential surface 25-2.

The jet ports 34-5 formed additionally in the outer wall surface 31-1 of the side wall 31 in the second embodiment jet the cleaning liquid 51, supplied from the cleaning liquid supply section 35 into the water passages 34 and having an ultrasonic wave applied thereto by the ultrasonic vibrators 36, toward the inner circumferential surfaces 26-1 of the grindstones 26 passing on the outer circumferential side of the side wall 31, thereby to clean the inner circumferential surfaces 26-1 of the grindstones 26 passing on the outer circumferential side of the side wall 31. The jet ports 34-5 formed additionally in the inner wall surface 32-1 of the side wall 32 in the second embodiment jet the cleaning liquid 51, supplied from the cleaning liquid supply section 35 into the water passages 34 and having an ultrasonic wave applied thereto by the ultrasonic vibrators 36, toward the outer circumferential surfaces 26-2 of the grindstones 26 passing on the inner circumferential side of the side wall 32, thereby to clean the outer circumferential surfaces 26-2 of the grindstones 26 passing the inner circumferential side of the side wall 32.

The grinding apparatus 1-2 according to the second embodiment configured as above produces effects similar to those of the grinding apparatus 1 according to the first embodiment. The grinding apparatus 1-2 according to the second embodiment, during grinding of the workpiece 100 by the grinding unit 20, uses the jet ports 34-5 formed additionally, in addition to the cleaning of the inner circumferential surface 25-1 and the outer circumferential surface 25-2 of the base 25 similarly to the grinding apparatus 1 according to the first embodiment, thereby to produce an effect that the inner circumferential surfaces 26-1 and the outer circumferential surfaces 26-2 of the grindstones 26 can be cleaned. As a result, the grinding apparatus 1-2 according to the second embodiment produces an effect that the possibility that the dirt on the inner circumferential surfaces 26-1 and the outer circumferential surfaces 26-2 of the grindstone 26 may drop onto the holding table 10 or into the grinding apparatus 1 at the time of exchange of the grinding wheel 22 can be reduced and the possibility of adhesion of the dirt to the workpiece 100 after grinding can be reduced.

### Third Embodiment

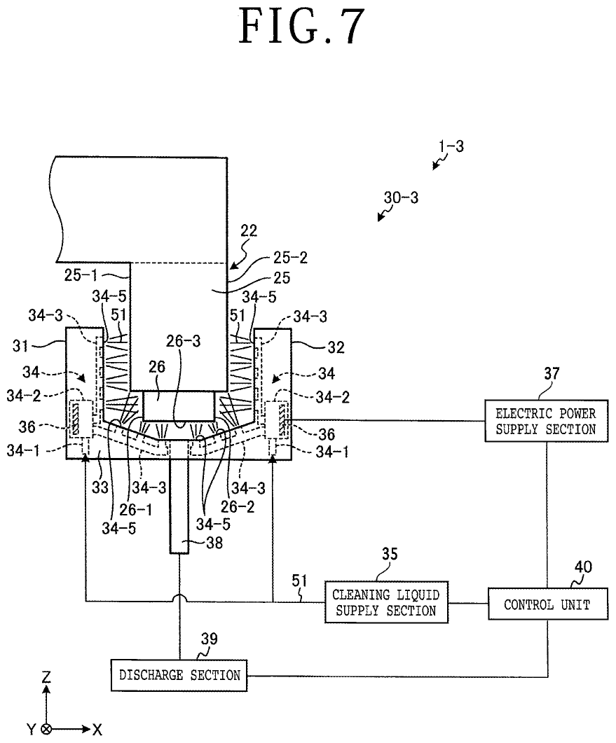

A grinding apparatus 1-3 according to a third embodiment of the present invention will be described based on the drawings. FIG. 7 is a sectional view in which a major part of the grinding apparatus 1-3 according to the third embodiment is enlarged. FIG. 7 denotes the same parts as those in the first and second embodiments by the same reference characters as used above, and descriptions thereof are omitted.

As illustrated in FIG. 7, an ultrasonic cleaning unit 30-3 of the grinding apparatus 1-3 according to the third embodiment is formed additionally with second water passages 34-3 for supplying the cleaning liquid 51 to the jet ports 34-5 for jetting the cleaning liquid 51 to the grinding surfaces 26-3 of the grindstones 26, in the inside of the bottom surface 33, in addition to the second water passages 34-3 formed inside the side walls 31 and 32 in the ultrasonic cleaning unit 30-2. The second water passages 34-3 formed additionally on the inner circumferential side relative to a radially central portion of the inside of the bottom surface 33 in the third embodiment have one-side ends thereof connected to the ultrasonic wave applying spaces 34-2 common with the second water passages 34-3 formed inside the side wall 31, and are formed on the other end side with a plurality of (in the third embodiment, three) jet ports 34-5 opening in the inclined surface 33-1 of the bottom surface 33. The second water passages 34-3 formed additionally on the outer circumferential side relative to the radially central portion of the inside of the bottom surface 33 in the third embodiment have one-side ends thereof connected to the ultrasonic wave applying spaces 34-2 common with the second water passages 34-3 formed inside the side wall 32, and are formed on the other end side with a plurality of (in the third embodiment, three) jet ports 34-5 opening in the inclined surface 33-2 of the bottom surface 33.

The jet ports 34-5 formed in the second water passages 34-3 formed additionally on the inner circumferential side relative to a radially central portion of the inside of the bottom surface 33 in the third embodiment jet the cleaning liquid 51, supplied from the cleaning liquid supply section 35 into the water passages 34 and having an ultrasonic wave applied thereto by the ultrasonic vibrators 36, toward a part on the inner circumferential side relative to radially central portions of the grinding surfaces 26-3 of the grindstones 26 passing on the upper side of the bottom surface 33, thereby to clean the part on the inner circumferential side relative to the radially central portions of the grinding surfaces 26-3 of the grindstones 26. The jet ports 34-5 formed in the second water passages 34-3 formed additionally on the outer circumferential side relative to the radially central portion of the inside of the bottom surface 33 in the third embodiment jet the cleaning liquid 51, supplied from the cleaning liquid supply section 35 into the water passages 34 and having an ultrasonic wave applied thereto by the ultrasonic vibrators 36, toward a part on the outer circumferential side relative to the radially central portions of the grinding surfaces 26-3 of the grindstones 26 passing on the upper side of the bottom surface 33, thereby to clean the part on the outer circumferential side relative to the radially central portions of the grinding surfaces 26-3 of the grindstones 26.

The grinding apparatus 1-3 according to the third embodiment configured as above produces effects similar to those of the grinding apparatus 1 according to the first embodiment and the grinding apparatus 1-2 according to the second embodiment. The grinding apparatus 1-3 according to the third embodiment, during grinding of the workpiece 100 by the grinding unit 20, uses the jet ports 34-5 formed additionally, in addition to the cleaning of the inner circumferential surface 25-1 and the outer circumferential surface 25-2 of the base 25 similar to the grinding apparatus 1 according to the first embodiment and in addition to the cleaning of the inner circumferential surfaces 26-1 and the outer circumferential surfaces 26-2 of the grindstones 26 similar to the grinding apparatus 1-2 according to the second embodiment, thereby to produce an effect that the grinding surfaces 26-3 of the grindstones 26 can be cleaned. As a result, the grinding apparatus 1-3 according to the third embodiment produces an effect that the possibility that the dirt on the grinding surfaces 26-3 of the grindstones 26 may drop onto the holding table 10 or into the grinding apparatus 1 at the time of exchange of the grinding wheel 22 can be reduced and the possibility of adhesion of the dirt to the workpiece 100 after grinding can be reduced.

### [Modification]

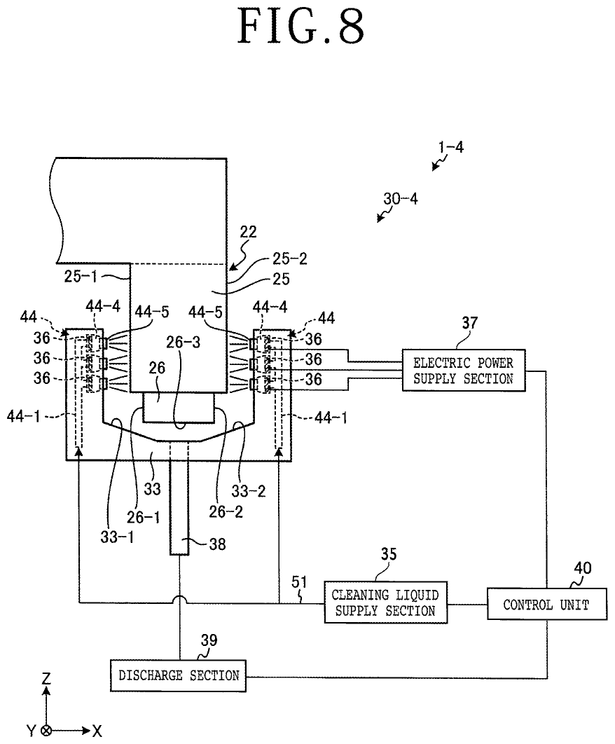

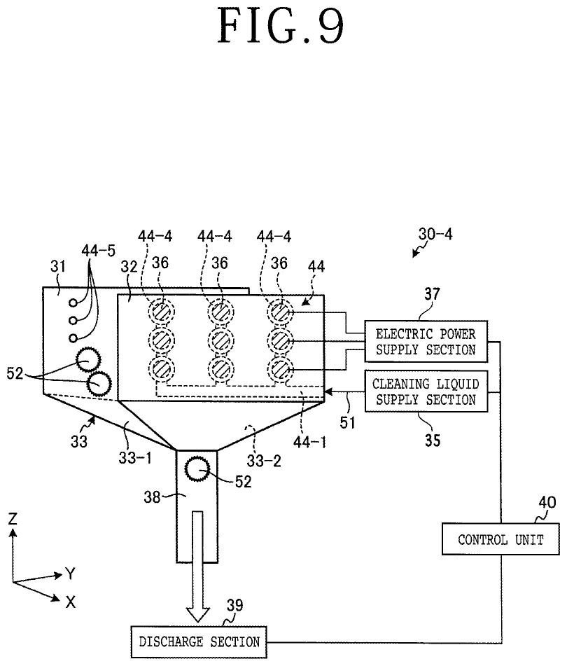

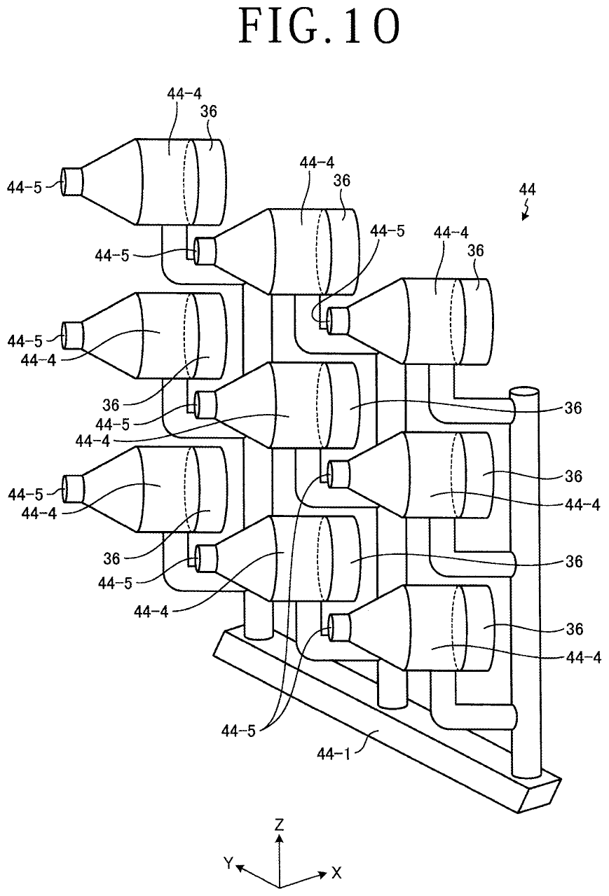

A grinding apparatus 1-4 according to a modification of the present invention will be described based on the drawings. FIG. 8 is a sectional view in which a major part of the grinding apparatus 1-4 according to the modification is enlarged. FIG. 9 is a perspective view depicting an ultrasonic cleaning unit 30-4 of the grinding apparatus 1-4 of FIG. 8. FIG. 10 is a perspective view depicting water passages 44 of the ultrasonic cleaning unit 30-4 of FIG. 8. FIGS. 8 to 10 denote the same parts as those in the first embodiment by the same reference characters as used above, and descriptions thereof are omitted.

As illustrated in FIG. 8, the grinding apparatus 1-4 according to the modification is the grinding apparatus 1 according to the first embodiment in which the ultrasonic cleaning unit 30 having the water passages 34 is changed to the ultrasonic cleaning unit 30-4 having the water passages 44.

As depicted in FIGS. 8, 9 and 10, the water passages 44 of the ultrasonic cleaning unit 30-4 of the grinding apparatus 1-4 according to the modification include first water passages 44-1, and a plurality of ultrasonic wave applying spaces 44-4 supplied with a cleaning liquid 51 from the first water passages 44-1, and the ultrasonic wave applying spaces 44-4 each have an ultrasonic vibrator 36 and a jet port 44-5. The water passages 44 of the modification are obtained by omitting the second water passages 34-3 of the first embodiment.

The first water passage 44-1 of the modification is similar to the first water passage 34-1 of the first embodiment, except that the number of branching to the other end side is increased. The ultrasonic wave applying spaces 44-4 of the modification are similar to the ultrasonic wave applying spaces 34-2 of the first embodiment, except that the number thereof connected to the other end of the first water passage 44-1 is increased, and the jet ports 44-5 are formed without intermediation by the second water passages 34-3. The jet ports 44-5 of the modification are similar to the jet ports 34-5 of the first embodiment, except for being formed in the ultrasonic wave applying spaces 44-4.

The grinding apparatus 1-4 according to the modification configured as above is the grinding apparatus 1 according to the first embodiment in which the water passages 34 of the ultrasonic cleaning unit 30 is changed to the water passages 44 obtained by omitting the second water passages 34-3, and, therefore, effects similar to those of the grinding apparatus 1 according to the first embodiment are produced. The grinding apparatus 1-4 according to the modification further produces an effect that the ultrasonic wave applying spaces 44-4 jet the cleaning liquid 51 from the jet ports 44-5 by vibration of the ultrasonic vibrators 36 in the ultrasonic wave applying spaces 44-5 and that an ultrasonic wave can be applied to the cleaning liquid 51 further immediately before jetting the cleaning liquid 51 from the jet ports 44-5. Therefore, the grinding apparatus 1-4 according to the modification can more securely jet the cleaning liquid 51, having an ultrasonic wave applied thereto, toward the inner circumferential surface 25-1 and the outer circumferential surface 25-2 of the base 25 of the grinding wheel 22, so that the cleaning effect for cleaning the inner circumferential surface 25-1 and the outer circumferential surface 25-2 of the base 25 of the grinding wheel 22 becomes higher. Note that, in the present invention, water passages configured similarly to the wafer passages 44 of the modification may be applied to the water passages 34 of the grinding apparatus 1-2 according to the second embodiment and the grinding apparatus 1-3 according to the third embodiment.

Note that the present invention is not limited to the above embodiments. In other words, the present invention can be carried out with various modifications in such ranges as not to depart from the gist of the invention. For example, the present invention also includes any form in which the jet ports 34-5 and 44-5 are formed in at least any one of the side walls 31 and 32 or the bottom surface 33 while being directed toward the inside of the roughly U-shaped part defined by the side walls 31 and 32 and the bottom surface 33. In addition, the present invention also includes any form in which the ultrasonic vibrator 36 is disposed in at least any one of the side walls 31 and 32 or the bottom surface 33. In other words, the present invention also includes any form in which the cleaning liquid 51 is jetted toward the base 25 or the grindstones 26 passing the outside-table route 29 by the jet ports 34-5 and 44-5 formed in the above-mentioned form, to clean the base 25 or the grindstones 26.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A grinding apparatus comprising:
a holding table that holds a workpiece and that is rotated;
a grinding wheel including an annular base fixed to a rotary spindle and a plurality of grindstones fixed to the base; and
an ultrasonic cleaning unit that cleans the annular base,
wherein the ultrasonic cleaning unit includes
side walls that surround the inside and the outside of the base and the grindstones,
a bottom surface that connects the side walls,
a jet port that is formed in at least either of the side walls or the bottom surface and that jets cleaning liquid toward either of the base or the grindstones,
a cleaning liquid supply section that supplies the cleaning liquid to the jet port,
an ultrasonic vibrator that applies an ultrasonic wave to the cleaning liquid supplied from the cleaning liquid supply section, and
an electric power supply section that applies electric power to the ultrasonic vibrator.

2. The grinding apparatus according to claim 1,
wherein the bottom surface is connected to a cleaning liquid discharge pipe, and is inclined so as to be lowered toward the part with which the cleaning liquid discharge pipe is connected.

3. The grinding apparatus according to claim 1,
wherein the ultrasonic vibrator is disposed at at least either of the side wall or the bottom surface.
